(19) United States
(12) Patent Application Publication
(10) Pub. No.: US 2025/0037026 A1
(43) Pub. Date: Jan. 30, 2025

(54) PREDICTION OF THE TIME EVOLUTION OF A PROCESS WITH IMPROVED CONSIDERATION OF PRIOR KNOWLEDGE ABOUT THE PROCESS

(71) Applicant: Robert Bosch GmbH, Stuttgart (DE)

(72) Inventors: Jan Rudolph, Stuttgart (DE); Maja Rudolph, Madison, WI (US)

(21) Appl. No.: 18/775,549

(22) Filed: Jul. 17, 2024

(30) Foreign Application Priority Data
Jul. 27, 2023 (DE) 10 2023 207 204.1

(51) Int. Cl. G06N 20/00

(52) U.S. Cl. CPC G06N 20/00

(57) ABSTRACT

A method for predicting the time evolution of a variable x that is influenced by a given process. The method includes: proceeding from the history Vₜ for the time step t, k candidates xₜ₊₁¹, . . . , xₜ₊₁^{k} are ascertained for the value xₜ₊₁ of the variable x in the time step t+1; for candidates xₜ₊₁¹, . . . , xₜ₊₁^{k}, scores sₜ₊₁¹, . . . , sₜ₊₁^{k} are ascertained in cooperation between a probabilistic model and a process model that represents prior knowledge about the given process; from the set of candidates xₜ₊₁¹, . . . , xₜ₊₁^{k}, a proper subset xₜ₊₁ⁱ, i∈I⊂{1, . . . , k}, is selected based on the associated scores sₜ₊₁¹, . . . , sₜ₊₁^{k}; proceeding from new selected candidates xₜ₊₁ⁱ for the time step t+1, l candidates xₜ₊₂¹, . . . , xₜ₊₂^{l} are ascertained for the value xₜ₊₂ of the variable x in the time step t+2.

### FIELD

The present invention relates to the prediction of the time evolution of variables that are influenced by a given process, wherein any prior knowledge about the process is available and utilized.

### BACKGROUND INFORMATION

Data-based probabilistic models are often used to predict the time evolution of variables that are relevant to technical processes. Such models use the previous progression of the variable to predict its future progression. In particular, they indicate how likely certain future values of the variable are, in view of previous time evolution.

The relationship between the previous progression and the future progression is determined by the mechanisms of action of the process under investigation. Thus, if a model has learned to predict the future evolution of the variable of interest on the basis of training time series of this variable, it has at least implicitly also learned these mechanisms of action.

The behavior of many technical processes follows previously known laws and/or is limited by hard boundary conditions. Therefore, only predictions of time evolution that are sufficiently compatible with these previously known laws and/or boundary conditions are suitable for practical use. Time evolutions that grossly violate these cannot actually be achieved.

### SUMMARY

The present invention provides a method for predicting the time evolution of a variable x that is influenced by a given process. This method uses an existing probabilistic model that, proceeding from a history Vₜ for a time step t, provides a conditional probability distribution p(xₜ₊₁|V_t) for the value xₜ₊₁ of the variable x.

According to an example embodiment of the present invention, the history Vₜ can in particular comprise, for example, the value xₜ of the variable x for the time step t, and/or any temporally preceding values xₜ₋ₖ of the variable x for preceding time steps t−k. This means in particular that the probabilistic model does not have to make the prediction based only on a single previous value, but can take into account a previous temporal progression. For example, the future steering angle of a vehicle can be predicted only with relatively high uncertainty based on a current value alone. However, if a more distant history is also taken into account, it can be recognized, for example, that the vehicle is currently cornering. The prediction of future values of the variable x can then in particular be a logical continuation of this cornering, for example.

Alternatively or else in combination therewith, the history Vₜ can also include any further context information Cₜ and/or Cₜ₋ₖ for the time step t, and/or any preceding time steps t−k. This context information Cₜ and/or Cₜ₋ₖ can be time-dependent or time-independent. For example, when monitoring an industrial process in an industrial plant, time-dependent context information Cₜ and/or Cₜ₋ₖ can refer to variables that occurred during previous processing steps. This history provides information on future useful changes to a measured variable x characterizing a current processing step and thus improves the prediction accuracy. The idea behind this is that the industrial process as a whole pursues a uniform, overarching goal and that the individual processing steps work together effectively to achieve this goal. Time-independent context information Cₜ and/or Cₜ₋ₖ can, for example, refer to the type of process, to properties of the machine and/or system, and/or to the product currently being manufactured. Context information Cₜ and/or Cₜ₋ₖ can also refer, for example, to operating conditions such as temperature, air pressure, humidity, or else energy prices at the location of the system. The age, number of operating hours and/or degree of wear and tear of machines or systems, for example, can also be taken into account. The number of hours already passed in the current shift of the operating personnel, for example, can also be taken into account. This can affect the reaction time of personnel to certain events, for example.

According to an example embodiment of the present invention, in this method, proceeding from the history Vₜ for the time step t, k candidates xₜ₊₁¹, . . . , xₜ₊₁^{k} are ascertained for the value xₜ₊₁ of the variable x in the time step t+1. If the measured variable x is a continuous variable, these candidates xₜ₊₁¹, . . . , xₜ₊₁^{k} can be sampled, for example, from an interval within which this measured variable can actually vary. For this sampling, an equidistant grid can be used, for example. If, on the other hand, the measured variable x is a discrete variable, the selection of candidates xₜ₊₁¹, . . . , xₜ₊₁^{k} is restricted from the outset to the possible values that this discrete variable can assume. For a discrete value x, the conditional probability distribution p(xₜ₊₁|xₜ) for the value xₜ₊₁ is therefore a categorical distribution.

For ascertained candidates xₜ₊₁¹, . . . , xₜ₊₁^{k}, scores sₜ₊₁¹, . . . , xₜ₊₁^{k} are ascertained in cooperation between the probabilistic model and a process model that represents prior knowledge about the given process. These scores are a measure of the probability that the candidate xₜ₊₁¹, . . . , xₜ₊₁^{k} in question corresponds to the actual value xₜ₊₁ of the variable x in the time step t+1. Statements from the probabilistic model can be offset against statements from the process model in any desired way. For example, if, as mentioned above, the process follows previously known laws and/or is restricted by boundary conditions, then the scores sₜ₊₁¹, . . . , sₜ₊₁^{k} of candidates xₜ₊₁¹, . . . , xₜ₊₁^{k} that violate these laws or boundary conditions can be reduced, for example by an additive or multiplicative “penalty.” In extreme cases, the violation itself can mean that the scores sₜ₊₁¹, . . . , sₜ₊₁^{k} are set to the worst possible value (e.g. 0). This is analogous to a situation in the product testing of electrical appliances when even a device that functions well will not get more than a “failing” rating if the housing is live.

From the set of candidates xₜ₊₁¹, . . . , xₜ₊₁^{k}, a proper subset xₜ₊₁ⁱ, i∈I⊂{1, . . . , k}, is selected on the basis of the associated scores sₜ₊₁¹, . . . , sₜ₊₁^{k}. Proceeding from new selected candidates xₜ₊₁ⁱ for the time step t+1, l candidates xₜ₊₂¹, . . . , xₜ₊₂^{l} are ascertained for the value xₜ₊₂ of the variable x in the time step t+2.

It was recognized that in this way, prior knowledge about the given process can be taken into account without having to touch the already existing probabilistic, data-based model. Thus, the performance of this probabilistic model is not degraded, as might otherwise happen when optimizing to a new optimization objective.

At the same time, as the above examples show, there is maximum flexibility as to how the prior knowledge is to be taken into account in detail.

The probabilistic model and the process model with the prior knowledge work synergistically together in such a way that the computational effort required to find the future time progression over multiple time steps that most likely corresponds to the true progression of the variable of interest is significantly reduced.

Proceeding from the history Vₜ, such as a value xₜ of the variable of interest x in the time step t, there are multiple candidates xₜ₊₁¹, . . . , xₜ₊₁^{k} for the value of the variable x in the next time step t+1. In order to ascertain the most likely prediction for the time step t+2, new candidates xₜ₊₂¹, . . . , xₜ₊₂^{k} would in turn have to be ascertained, proceeding from each candidate xₜ₊₁¹, . . . , xₜ₊₁^{k}, for the value of the variable x at the time step t+2. A whole tree of candidate time progressions of the variable of interest x would have to be examined. The number of candidate time progressions in this tree grows exponentially with the number of time steps over which the prediction extends.

In this situation, a lot of effort can be saved if as many candidates as possible are eliminated at the earliest possible level of the tree and not further investigated for later time steps. This is somewhat comparable to a situation in the early stages of an epidemic, in which the cautious behavior of a single person, who infects nobody rather than three people (who then in turn do not infect three more people each, and so on), has a surprisingly large impact on the total number of cases.

The price for this is that a global optimum may be missed. In principle, it is possible that the first time step of a time evolution receives only a moderate score from the probabilistic model, but is followed by further time steps with very good scores. At the end of a prediction horizon of, for example, four or five time steps, the moderate score of the first time step has long been “forgotten,” and the overall score of this time evolution still beats the overall score of other time evolutions that started very promisingly in the first time step and were disappointing later.

According to an example embodiment of the present invention, in order to reduce the probability that a later turnaround toward an ultimately very good time evolution is missed by rejecting candidates at an early stage, it is therefore advantageous preferably to reject the candidates for which there are other valid reasons not to investigate them further, in addition to just the probabilistic score. This is where the process model comes into play: It can in particular, for example, identify candidates xₜ₊₁¹, . . . , xₜ₊₁^{k} for the value of the variable x at the time step t+1 that will not occur in this form in any case, because they represent states of the process that are not attainable, for instance due to the known functioning principle of this process or due to hard boundary conditions. If, for example, a candidate xₜ₊₁¹, . . . , xₜ₊₁^{k} does not comply with the law of conservation of energy, a law of thermodynamics or another mandatory physical requirement, any further time evolution based on this candidate xₜ₊₁¹, . . . , xₜ₊₁^{k} is irrelevant from the outset because there is no way to get there. This is approximately comparable to a situation in which it is useless for mountaineers in distress to philosophize about how they could get their situation under control in no time at all with a certain piece of equipment, which has been unfortunately left at home. The mountaineers can immediately forget about any plans that require the presence of this particular piece of equipment, because discussing it only costs time, which they do not have. In this situation, anyone who focuses their energy on the alternatives that are feasible with the equipment available significantly increases their chances of survival.

Thus, in a particularly advantageous embodiment of the present invention, the process model includes boundary conditions that the time evolution of the variable x and/or a resulting behavior of the process must fulfill. Whoever rejects candidates xₜ₊₁¹, . . . , xₜ₊₁^{k} that can never be realized due to a violation of hard boundary conditions cannot do anything wrong.

Examples of particularly hard boundary conditions that can be used in this context are
a mechanical or electrical constraint, and/or
compliance with a physical conservation law, and/or
the fulfillment of a physical continuity equation.

In a particularly advantageous embodiment of the present invention, the scores sₜ₊₁¹, . . . , sₜ₊₁^{k} include a product of a first contribution from the probabilistic model and a second contribution from the process model. These two contributions can, for example, be weighted against each other by a constant factor. In particular, it can be expressed by a contribution 1 of the process model that all boundary conditions are met and that the process will develop as described by the probabilistic model. On the other hand, non-feasible candidates xₜ₊₁¹, . . . , xₜ₊₁^{k} can be excluded from further consideration by a contribution 0 of the process model. Thus, the contribution from the process model is advantageously 1 when the boundary conditions are fully met and 0 when at least one boundary condition is clearly not met.

The selection of the proper subset xₜ₊₁ⁱ, i∈l⊂{1, . . . , k} of candidates xₜ₊₁¹, . . . , xₜ₊₁^{k} based on the scores sₜ₊₁¹, . . . , sₜ₊₁^{k} can be done according to any suitable criteria.

For example, the top-n candidates xₜ₊₁¹, . . . , xₜ₊₁^{k} with the best scores sₜ₊₁¹, . . . , sₜ₊₁^{k} can be included in the proper subset xᵢ₊₁ⁱ, i∈I⊂{1, . . . , k}. Because more than one candidate is considered, it is possible in particular to maintain the possibility that a time progression that was not initially at the top may subsequently improve.

Alternatively or in combination, according to an example embodiment of the present invention, the candidates xₜ₊₁¹, . . . , xₜ₊₁^{k} with scores sₜ₊₁¹, . . . , sₜ₊₁^{k} exceeding a predefined threshold can be included in the proper subset xₜ₊₁ⁱ, i∈I⊂{1, . . . , k}. In this way, it can be ensured that, from a set of very bad candidates xₜ₊₁¹, . . . , xₜ₊₁^{k}, a candidate that only got a slightly better score sₜ₊₁¹, . . . , sₜ₊₁^{k} by chance is not automatically selected as the best candidate. Rather, it is quite possible for the subset xₜ₊₁ⁱ, i∈I⊂{1, . . . , k} to be empty. This can then be interpreted as an error signal that the actual behavior of the process can no longer be described by the probabilistic model. An operator of the process can thereby be prompted to look for the error, for example a defect in equipment.

In a further advantageous embodiment of the present invention, a process model is selected that describes the behavior of the process with at least one differential equation. In particular, differential equations can be used, for example, to predict the behavior of the process over time, with certain simplifying assumptions. A candidate xₜ₊₁¹, . . . , xₜ₊₁^{k} that is consistent with the behavior predicted by the differential equation is therefore more likely to reflect the actual expected behavior of the process than a candidate xₜ₊₁¹, . . . , xₜ₊₁^{k} that cannot be explained at all by the differential equation.

For example, at least one differential equation can be an ordinary differential equation. A contribution from the process model to the score sₜ₊₁¹, . . . , sₜ₊₁^{k} can then measure the extent to which candidates xₜ₊₁¹, . . . , xₜ₊₁^{k} deviate from predictions ascertained using the ordinary differential equation. There will always be certain deviations when the probabilistic model is trained on real data of the process, because the differential equation is a simplified description of the process.

For example, it is also possible for at least one differential equation to be a stochastic differential equation. A stochastic differential equation provides a probability distribution for future expected values of the variable of interest x. A contribution from the process model to the score sₜ₊₁¹, . . . , sₜ₊₁^{k} can then measure how likely candidates xₜ₊₁¹, . . . , xₜ₊₁^{k} are in light of such a probability distribution. This contribution therefore does not require reinterpretation from a deviation to a probability, but is directly available as a probability.

In another particularly advantageous embodiment of the present invention, candidates xₜ₊ₙ^{j} and associated scores sₜ₊ₙ^{j} where n≥0 are kept on a list sorted by the scores sₜ₊ₙ¹, . . . , sₜ₊ₙ^{k}. From this list, the candidate xₜ₊ₙⁱ with the best score sₜ₊ₙⁱ is selected. Proceeding from this candidate xₜ₊ₙⁱ, new candidates xₜ₊ₙ₊₁^{l} are ascertained for the value xₜ₊ₙ₊₁ of the variable x in the time step t+n+1. The list may well contain candidates xₜ₊ₙ^{j} that refer to different future time steps t+n. Work then always proceeds on the candidate xₜ₊ₙ^{j} that, according to the current state of knowledge, is most likely to correspond to the actual value xₜ₊ₙ of the variable x in the time step t+n. It can then happen, for example, that a candidate x¹ is initially top of the list over the time steps t+1 and t+2, but is then advanced in the time step t+3 only with possibilities that all have poor scores. All these possibilities can then, for example, fall behind the score of a candidate x² that was previously in second place on the list with an evolution up to time step t+1. Subsequently, the time evolution of the candidate x² is advanced to the time step t+2 and, if the score is still at the top of the list, to the time step t+3.

In a further particularly advantageous embodiment of the present invention, every time a score sₜ₊₁¹, . . . , sₜ₊₁^{k} is ascertained for a candidate xₜ₊₁¹, . . . , xₜ₊₁^{k}, this candidate xₜ₊₁¹, . . . , xₜ₊₁^{k} is sorted into the list. The candidate xₜ₊ₙⁱ with the best score sₜ₊ₙⁱ is then selected from the list updated in this way. In particular, it is then not necessary, for example, to examine all the possible ways of getting from the time step t+1 to the time step t+2 first before examining the first further evolution of a candidate from the time step t+2 to the time step t+3. Rather, the first possibility can be directly investigated further up to later time steps t+3,t+4, etc., as long as it is promising.

In a further particularly advantageous embodiment of the present invention, the list has a predefined capacity, and when this is exceeded, the candidate xₜ₊ₙ^{j} with the worst score sₜ₊ₙ^{j} is rejected. This predefined capacity can be used to set the search strategy. If the list has infinite capacity, the search strategy switches to a full search of the tree of possibilities, with an effort that grows exponentially with the number of time steps. If the list has a capacity of only one candidate, the search strategy switches to the “greedy algorithm”, which always only looks for the best option in the next time step, then considers this time step as completed and immediately moves on to the next time step. With capacities between 1 and infinity, any intermediate form between the “greedy algorithm” and the full search can be set. Such intermediate forms are also called “beam search.” The beam search examines a graph by selecting the most promising node from an available number of nodes at each step and then expanding it further. Compared to the search with the “greedy algorithm,” the beam search therefore takes into account the entire predicted temporal sequence.

The limited capacity of the list ensures that, on the one hand, the heuristic search is faster than the full search of the tree of possibilities and, on the other hand, the memory requirements do not get out of hand. As previously explained, the cost of this is that the ultimately predicted time evolution of the variable x is not necessarily the most accurate prediction. There is no longer any guarantee that the global optimum is not hidden behind one of the candidates xₜ₊₁¹, . . . , xₜ₊₁^{k} that were rejected early at the time step t+1. However, the probability of this happening is reduced by taking into account prior knowledge in the process model. In a specific application, what is usually required is not one optimal result, but a practically usable result within a limited time and with limited hardware resources.

In a further particularly advantageous embodiment of the present invention, a control signal is ascertained from the ascertained time evolution of the variable x. A vehicle, a driver assistance system, a robot, an electrical tool, an electrical household appliance, and/or a medical diagnostic device is controlled with the control signal. In this way, the probability is increased that the reaction performed by the system being controlled is appropriate to the situation embodied in the time evolution of the variable x.

In vehicle applications, for example, time evolutions of the speed or trajectories of vehicles can be predicted. Predicted time evolutions of speed can, for example, be used to simulate the exhaust behavior of vehicles in order to ascertain whether the pollutant emissions of these vehicles meet the legal requirements under realistic driving conditions. In particular, these can be used to investigate how the exhaust behavior depends on parameters of the engine control unit, for example, so that a vehicle seeking a new type approval can pass the exhaust gas tests under real conditions on the first attempt, if possible. Predicted trajectories of the ego vehicle and other road users can be used, for example, to make the at least partially automated driving of vehicles more predictive. If, for example, it is foreseeable that the vehicle will have to slow down or even stop due to traffic, the motor of an electrically powered vehicle can be switched to generator mode in order to store at least part of the kinetic energy in the battery. Predicted trajectories can also be used to ascertain the total load on components and, for example, to initiate condition-based maintenance. Similarly, for electrical tools or household appliances, a state of wear can be predicted as the variable of interest x, and corresponding condition-based maintenance can be initiated.

In human-driven vehicles, for example, the driver's behavior can also be predicted as the variable of interest x. A variety of data sources can be used for this purpose, such as video recordings of eye movements, steering movements or health data, such as heart rate, ascertained by the driver's smartwatch. For example, the time evolution of the driver's state of fatigue or exhaustion can be predicted in order to be able to output corresponding warnings more precisely. If it is foreseeable that the driver will reach the destination without any problems, it makes little sense to bombard them with warnings along the way. These warnings could ultimately become a self-fulfilling prophecy and make the driver even more inattentive. If, however, it is foreseeable that the destination can no longer be reached safely, it is advisable to make the driver aware of this at an early stage so that they can look for an alternative.

In the field of smart residential and factory buildings, for example, the concentrations of oxygen or carbon dioxide, the humidity, the pollution of the atmosphere or the temperature can be predicted as variables of interest x. In this way, measures can be proactively initiated to improve the indoor climate. For example, an energy-efficient underfloor heating system has high thermal inertia, so it should be activated early when needed to prevent the room temperature from dropping too much, which in turn could tempt residents to use an electric fan heater, which negates the energy efficiency of the underfloor heating. Also, for example, if the room is expected to heat up significantly, an air conditioning system can be proactively switched on at times when electrical energy is particularly cheap.

In all these and other applications, the selection of promising candidates xₜ₊₁¹, . . . , xₜ₊₁^{k} for the next time step t+1 can be improved by taking into account relevant prior knowledge in the process model as described here, so that candidates xₜ₊₁¹, . . . , xₜ₊₁^{k} relating to states that are not actually attainable are rejected at an early stage.

The method of the present invention can in particular be wholly or partially computer-implemented. The present invention therefore also relates to a computer program comprising machine-readable instructions that, when executed on one or more computers and/or compute instances, cause the computer(s) to execute the described method of the present invention. In this sense, control devices for vehicles and embedded systems for technical devices, which are also capable of executing machine-readable instructions, are also to be regarded as computers. Compute instances are, for example, virtual machines, containers or other execution environments in which computing capacity is provided in a cloud.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to figures.

### BRIEF DESCRIPTION OF THE DRAWINGS

FIG. 1 shows an exemplary embodiment of the method 100 for predicting the time evolution of a variable x, according to the present invention.

FIG. 2 shows an exemplary time evolution of a list of candidates xₜ₊₁¹, . . . , xₜ₊₁^{k} ordered by scores sₜ₊₁¹, . . . , sₜ₊₁¹, according to the present invention.

### DETAILED DESCRIPTION OF EXAMPLE EMBODIMENTS

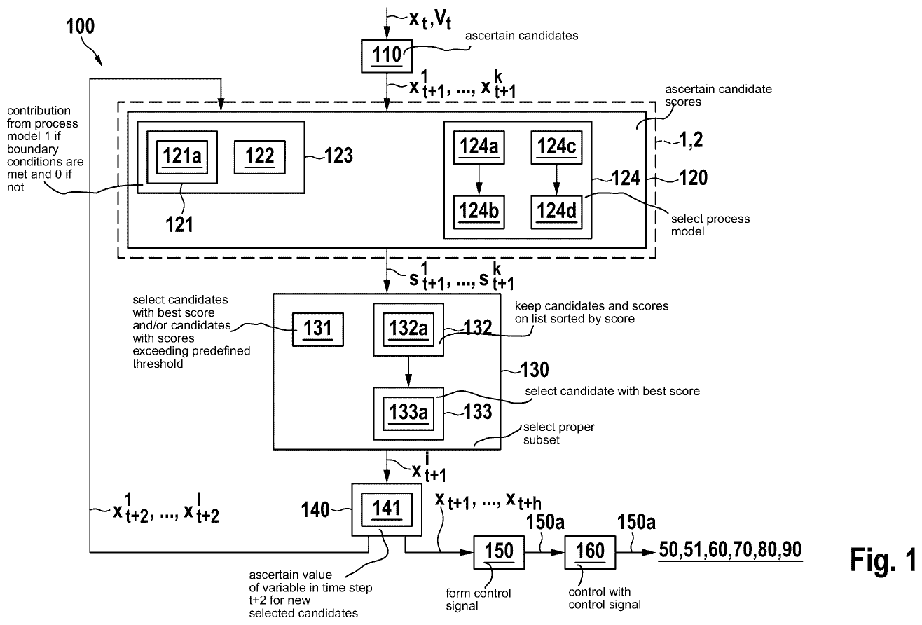

FIG. 1 is a schematic flow diagram of an exemplary embodiment of the method 100 for predicting the time evolution of a variable x that is influenced by a given process. For this prediction, a probabilistic model 1 is used, which, for a given history Vₜ at the time step t, provides a conditional probability distribution p(xₜ₊₁|Vₜ) for the value xₜ₊₁ of the variable x. A process model 2 that represents prior knowledge about the given process is also used.

In step 110, proceeding from the history Vₜ for the time step t, k candidates xₜ₊₁¹, . . . , xₜ₊₁^{k} are ascertained for the value xₜ₊₁ of the variable x in the time step t+1.

In step 120, for candidates xₜ₊₁¹, . . . , xₜ₊₁^{k} scores sₜ₊₁¹, . . . , sₜ₊₁^{k} are ascertained in cooperation between the probabilistic model 1 and the process model 2. These scores sₜ₊₁¹, . . . , sₜ₊₁^{k} are a measure of the probability that the candidate xₜ₊₁¹, . . . , xₜ₊₁^{k} in question corresponds to the actual value xₜ₊₁ of the variable x in the time step t+1.

In step 130, from the set of candidates xₜ₊₁¹, . . . , xₜ₊₁^{k}, a proper subset xₜ₊₁^{k}, i∈l⊂{1, . . . , k}, is selected on the basis of the associated scores sₜ₊₁¹, . . . , sₜ₊₁^{k}.

In step 140, proceeding from new selected candidates xₜ₊₁ⁱ for the time step t+1, l candidates xₜ₊₁¹, . . . , xₜ₊₁^{l} are ascertained for the value xₜ₊₂ of the variable x in the time step t+2. These l candidates xₜ₊₂¹, . . . , xₜ₊₂^{l} can then be fed back to step 120. That is, for the l candidates xₜ₊₂¹, . . . , xₜ₊₂^{l}, scores sₜ₊₁¹, . . . , sₜ₊₁^{l} can then be ascertained again, and a subset of promising candidates xₜ₊₂ⁱ, i∈l⊂{1, . . . , l}, can be selected for further pursuit in the time step t+3.

In this way, from the history Vₜ for the time step t, i.e., for example, proceeding from the value xₜ of the measured variable x at the time step t, a prediction xₜ₊₁, . . . , xₓ₊ₕ for the measured variable x can be ascertained successively over a horizon of h time steps into the future.

In the example shown in FIG. 1, in step 150, a control signal is formed from this ascertained prediction xₜ₊₁, . . . , xₓ₊ₕ. In step 160, a vehicle 50, a driver assistance system 51, a robot 60, an electrical tool 70, an electrical household appliance 80, and/or a medical diagnostic device 90 is controlled with this control signal 150a.

According to block 121, the process model 2 can include boundary conditions that the time evolution of the variable x and/or a behavior of the process resulting from this time evolution must fulfill. According to block 121a, these boundary conditions can include in particular, for example,
a mechanical or electrical constraint, and/or
compliance with a physical conservation law, and/or
the fulfillment of a physical continuity equation.

According to block 122, the scores sₜ₊₁¹, . . . , sₜ₊₁^{k} can include a product of a first contribution from the probabilistic model 1 and a second contribution from the process model 2.

In particular, according to block 123, the contribution from the process model can be 1 if the boundary conditions are met and 0 if at least one boundary condition is not met. As previously explained, this allows candidates xₜ₊₁¹, . . . , xₜ₊₁^{k} that do not satisfy the boundary conditions to be completely eliminated from further investigation, since they are not attainable in practice anyway.

According to block 124, a process model 2 can be selected that describes the behavior of the process with at least one differential equation.

In particular, for example according to block 124a, at least one differential equation can be an ordinary differential equation. According to block 124b, a contribution from the process model 2 to the score sₜ₊₁¹, . . . , sₜ₊₁^{k} can then measure the extent to which candidates xₜ₊₁¹, . . . , xₜ₊₁^{k} deviate from predictions ascertained using the ordinary differential equation.

Alternatively or in combination, according to block 124c, at least one differential equation can be a stochastic differential equation. According to block 124d, a contribution from the process model (2) to the score sₜ₊₁¹, . . . , sₜ₊₁^{k} can then measure how likely candidates xₜ₊₁¹, . . . , xₜ₊₁^{k} are in light of a probability distribution ascertained using the stochastic differential equation.

According to block 131,
the top-n candidates xₜ₊₁¹, . . . , xₜ₊₁^{k} with the best scores sₜ₊₁¹, . . . , sₜ₊₁¹, and/or
the candidates xₜ₊₁¹, . . . , xₜ₊₁^{k} with scores sₜ₊₁¹, . . . , sₜ₊₁^{k} exceeding a predefined threshold
   can be included in the proper subset xₜ₊₁ⁱ, i∈I⊂{1, . . . , k} of the candidates to be considered for further time steps.

According to block 132, candidates xₜ₊ₙ^{j} and associated scores sₜ₊ₙ^{j} where n≥0 can be kept on a list sorted by the scores sₜ₊ₙ¹, . . . , sₜ₊ₙ^{k}. According to block 133, the candidate xₜ₊ₙ^{j} with the best score sₜ₊ₙⁱ can then be selected therefrom. According to block 141, proceeding from this candidate xₜ₊ₙⁱ, new candidates xₜ₊ₙ₊₁^{l} can then be ascertained for the value xₜ₊ₙ₊₁ of the variable x in the time step t+n+1.

In particular, according to block 132a, every time a score sₜ₊₁¹, . . . , sₜ₊₁^{k} is ascertained for a candidate xₜ₊₁¹, . . . , xₜ₊₁^{k}, this candidate xₜ₊₁¹, . . . , xₜ₊₁^{k} can be sorted into the list. According to block 133a, the candidate xₜ₊ₙⁱ with the best score sₜ₊ₙⁱ can then be selected from the list updated in this way.

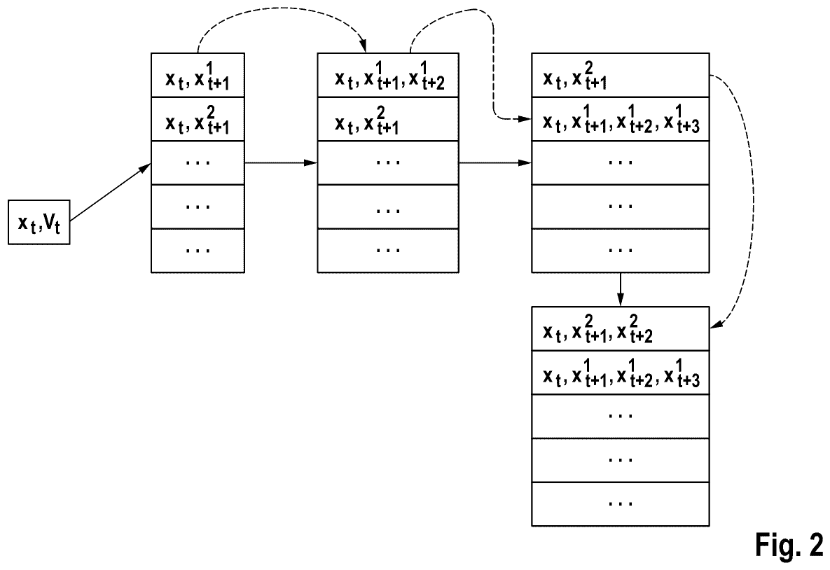

FIG. 2 shows by way of example how a promising prediction of the variable of interest x can be ascertained over multiple time steps using a list of candidates xₜ₊ₙ^{j} sorted by scores sₜ₊ₙ^{j}.

The prediction proceeds from the history Vₜ for the time step t, such as a value xₜ of the variable x at the time step t. From this, multiple candidates are ascertained for the value of the variable x in the first future time step t+1, of which only two candidates xₜ₊₁¹ and xₜ₊₁² are shown for the sake of clarity. In the example shown in FIG. 2, in the list ordered by scores sₜ₊ₙ^{j}, the candidate xₜ₊₁¹ is in first place and the candidate xₜ₊₁² is in second place.

To continue the prediction at the time step t+2, only the candidate xₜ₊₁¹ is pursued. This means that for this candidate xₜ₊₁¹ further candidates are calculated for the time step t+2. The candidate xₜ₊₁² remains unchanged. In the example shown in FIG. 2, the candidate xₜ₊₂¹ has such a good score that it tops the list ahead of the candidate xₜ₊₁², which was only calculated up to time step t+1.

However, if the most promising candidate xₜ₊₂¹ is then advanced to the time step t+3, there is the “nasty surprise” that all the candidates generated in this way have poor scores. The best score is that of candidate xₜ₊₃¹, but even this is worse than the score of the previously second-placed candidate xₜ₊₁², which was only calculated up to the time step t+1. Therefore, there is now a change at the top of the list: The candidate xₜ₊₁² comes in first place, while the candidate xₜ₊₃¹ only comes in second place.

This in turn has the result that in the next step the candidate xₜ₊₁² is advanced to the time step t+2. The candidate xₜ₊₃¹ remains unchanged. It is second on the list behind the new candidate xₜ₊₂².

In this example, therefore, the heuristic search strategy is better than the greedy algorithm, which does not take into account dependencies between the time steps and would therefore have definitively rejected the candidate xₜ₊₁² at an early stage.

1-17. (canceled)

18. A method for predicting a time evolution of a variable x that is influenced by a given process, using a given probabilistic model that, for a given history Vₜ at time step t, provides a conditional probability distribution p(xₜ₊₁|Vₜ) for a value xₜ₊₁ of the variable x, the method comprising the following steps:
proceeding from the history Vₜ for the time step t, ascertaining k candidates xₜ₊₁¹, . . . , xₜ₊₁^{k} for the value xₜ₊₁ of the variable x in a time step t+1;
for the candidates xₜ₊₁¹, . . . , xₜ₊₁^{k}, ascertaining respective scores sₜ₊₁¹, . . . , sₜ₊₁^{k} in cooperation between the probabilistic model and a process model that represents prior knowledge about the given process, each score being a measure of a probability that the respective candidate xₜ₊₁¹, . . . , xₜ₊₁^{k} corresponds to an actual value xₜ₊₁ of the variable x in the time step t+1;
from a set of the candidates xₜ₊₁¹, . . . , xₜ₊₁^{k}, selecting a proper subset xₜ₊₁ⁱ, i∈I⊂{1, . . . , k}, of the candidates based on the respective scores sₜ₊₁¹, . . . , sₜ₊₁^{k},
proceeding from the selected candidates xₜ₊₁ⁱ for the time step t+1;
ascertaining l candidates xₜ₊₂¹, . . . , xₜ₊₂^{l} for a value xₜ₊₂ of the variable x in a time step t+2.

19. The method according to claim 18, wherein the process model includes boundary conditions that the time evolution of the variable x and/or a behavior of the process resulting from the time evolution must fulfill.

20. The method according to claim 19, wherein at least one of the boundary conditions includes:
(i) a mechanical or electrical constraint, and/or
(ii) compliance with a physical conservation law, and/or
(iii) the fulfillment of a physical continuity equation.

21. The method according to claim 18, wherein each of the respective scores sₜ₊₁¹, . . . , sₜ₊₁^{k} include a product of a first contribution from the probabilistic model and a second contribution from the process model.

22. The method according to 19, wherein each of the respective scores sₜ₊ₖ¹, . . . , sₜ₊₁^{k} include a product of a first contribution from the probabilistic model and a second contribution from the process model, and wherein the first contribution from the process model is 1 when the boundary conditions are met and 0 when at least one boundary condition is not met.

23. The method according to claim 18, wherein: (i) a top-n candidates xₜ₊₁¹, . . . xₜ₊₁^{k} with respective best scores sₜ₊₁¹, . . . , sₜ₊₁^{k}, and/or candidates xₜ₊₁¹, . . . , xₜ₊₁^{k} with scores sₜ₊₁¹, . . . , sₜ₊₁^{k} exceeding a predefined threshold, are included in the proper subset xₜ₊₁i, i∈I⊂{1, . . . , k}.

24. The method according to claim 18, wherein the process model describes a behavior of the process with at least one differential equation.

25. The method according to claim 24, wherein:
the at least one differential equation includes an ordinary differential equation, and
a contribution from the process model to each of the respective scores sₜ₊₁¹, . . . , sₜ₊₁^{k} measures an extent to which the candidates xₜ₊₁¹, . . . , xₜ₊₁^{k} deviate from predictions ascertained using the ordinary differential equation.

26. The method according to claim 24, wherein:
the at least one differential equation includes a stochastic differential equation, and
a contribution from the process model to the respective scores sₜ₊₁¹, . . . , sₜ₊₁^{k} measures how likely the candidates xₜ₊₁¹, . . . , xₜ₊₁^{k} are in light of a probability distribution ascertained using the stochastic differential equation.

27. The method according to claim 18, wherein:
the candidates xₜ₊ₙ^{j} and the respective scores sₜ₊ₙ^{j} where n≥0 are kept on a list sorted by the scores sₜ₊ₙ¹, . . . , sₜ₊₁^{k},
a candidate xₜ₊ₙⁱ of the candidates with a best score sₜ₊ₙⁱ is selected from the list, and
proceeding from the selected candidate xₜ₊ₙⁱ, new candidates xₜ₊ₙ₊₁ⁱ are ascertained for a value xₜ₊ₙ₊₁ of the variable x in a time step t+n+1.

28. The method according to claim 27, wherein:
every time a respective score sₜ₊₁¹, . . . , sₜ₊₁^{k} is ascertained for a candidate xₜ₊₁¹, . . . , xₜ₊₁^{k}, the candidate xₜ₊₁¹, . . . , xₜ₊₁^{k} for which the respective score is ascertained is sorted into the list to updated the list, and
a candidate xₜ₊ₙⁱ of the candidates with the best score sₜ₊ₙⁱ is selected from the list updated in this way.

29. The method according to claim 27, wherein the list has a predefined capacity, and when the predefine capacity is exceeded, a candidate xₜ₊ₙ^{j} with a worst respective score sₜ₊ₙ^{j} is rejected.

30. The method according to claim 18, wherein:
a control signal is ascertained from the ascertained time evolution of the variable x, and
a vehicle, and/or a driver assistance system, and/or a robot, and/or an electrical tool, and/or an electrical household appliance, and/or a medical diagnostic device, is controlled with the control signal.

31. The method according to claim 18, wherein the history Vₜ includes
(i) the value xₜ of the variable x for the time step t, and/or
(ii) temporally preceding values xₜ₋ₖ of the variable x for preceding time steps t−k, k>0, and/or
(iii) context information Cₜ and/or Cₜ₋ₖ for the time step t, and/or any preceding time steps t−k, k>0.

32. A non-transitory machine-readable data carrier on which is stored a computer program including machine-readable instructions for predicting a time evolution of a variable x that is influenced by a given process, using a given probabilistic model that, for a given history Vₜ at time step t, provides a conditional probability distribution p(xₜ₊₁|Vₜ) for a value xₜ₊₁ of the variable x, the instructions, when executed by one or more computers and/or compute instances, causing the one or more computers and/or compute instances to perform the following steps:
proceeding from the history Vₜ for the time step t, ascertaining k candidates xₜ₊₁¹, . . . , xₜ₊₁^{k} for the value xₜ₊₁ of the variable x in a time step t+1;
for the candidates xₜ₊₁¹, . . . , xₜ₊₁^{k}, ascertaining respective scores sₜ₊₁¹, . . . , sₜ₊₁^{k} in cooperation between the probabilistic model and a process model that represents prior knowledge about the given process, each score being a measure of a probability that the respective candidate xₜ₊₁¹, . . . , xₜ₊₁^{k} corresponds to an actual value xₜ₊₁ of the variable x in the time step t+1;
from a set of the candidates xₜ₊₁¹, . . . , xₜ₊₁^{k}, selecting a proper subset xₜ₊₁ⁱ, i∈I⊂{1, . . . , k}, of the candidates based on the respective scores sₜ₊₁¹, . . . , sₜ₊₁^{k},
proceeding from the selected candidates xₜ₊₁ⁱ for the time step t+1; ascertaining l candidates xₜ₊₂¹, . . . , xₜ₊₂^{l} for a value xₜ₊₂ of the variable x in a time step t+2.

33. One or more computers and/or compute instances equipped with a non-transitory machine-readable data carrier on which is stored a computer program including machine-readable instructions for predicting a time evolution of a variable x that is influenced by a given process, using a given probabilistic model that, for a given history Vₜ at time step t, provides a conditional probability distribution p(xₜ₊₁|Vₜ) for a value xₜ₊₁ of the variable x, the instructions, when executed by the one or more computers and/or compute instances, causing the one or more computers and/or compute instances to perform the following steps:
proceeding from the history Vₜ for the time step t, ascertaining k candidates xₜ₊₁¹, . . . , xₜ₊₁^{k} for the value xₜ₊₁ of the variable x in a time step t+1;
for the candidates xₜ₊₁¹, . . . , xₜ₊₁^{k}, ascertaining respective scores sₜ₊₁¹, . . . , sₜ₊₁^{k} in cooperation between the probabilistic model and a process model that represents prior knowledge about the given process, each score being a measure of a probability that the respective candidate xₜ₊₁¹, . . . , xₜ₊₁^{k} corresponds to an actual value xₜ₊₁ of the variable x in the time step t+1;
from a set of the candidates xₜ₊₁¹, . . . , xₜ₊₁^{k}, selecting a proper subset xₜ₊₁ⁱ, i∈I⊂{1, . . . , k}, of the candidates based on the respective scores sₜ₊₁¹, . . . , sₜ₊₁^{k};
proceeding from the selected candidates xₜ₊₁ⁱ for the time step t+1;
ascertaining l candidates xₜ₊₂¹, . . . , xₜ₊₂^{l} for a value xₜ₊₂ of the variable x in a time step t+2.
